(19) United States
(12) Patent Application Publication
(10) Pub. No.: US 2011/0101794 A1
(43) Pub. Date: May 5, 2011

(54) Portable Power Supply Device

(76) Inventors: Kirk Schroeder, Steinbach (CA); Dion Friesen, Steinbach (CA)

(21) Appl. No.: 12/677,130

(22) PCT Filed: Jul. 21, 2009
(86) PCT No.: PCT/CA2009/000988

§ 371 Date: Mar. 9, 2010

Related U.S. Application Data
(60) Provisional application No. 61/082,260, filed on Jul. 21, 2008.

(51) Int. Cl. H02J 7/00; H02J 7/32

(52) U.S. Cl. 307/150; 320/101

(57) ABSTRACT

A portable power supply device comprises a stackable battery housing locating a plurality of batteries therein and an inverter housing locating an inverter therein which is arranged to convert the direct current from the batteries to an alternating current. The inverter housing is readily separable from the battery housing such that one or more battery housings can be readily interchangeable to provide a constant supply of power and to allow a variety of charging configurations of the batteries. First electrical connectors on the battery housing and second electrical connectors on the inverter housing automatically connect the inverter to the batteries upon stacking of the inverter housing on the battery housing. Furthermore charging terminals are mounted externally on the inverter housing for ready access to connect to a charging device in a convenient manner without requiring the housings to be opened or separated form one another.

This application claims priority benefits from U.S. provisional application No. 61/082,260 filed Jul. 21, 2008.

### FIELD OF THE INVENTION

The present invention relates to a portable power supply device in which an electrical power inverter converts direct current power supplied from a plurality of batteries to an alternating current power supply in a portable configuration.

### BACKGROUND

The use of portable power supply device is known to be desirable in locations where conventional grid power is unavailable, for example construction sites or remote areas.

US publications 2007/0013340 belonging to Mattichak and 2007/0019453 belonging to Pierce disclose examples of portable power supply devices having limited application. In each instance, only low amounts of power are provided, typically for providing electrical power to a few basic essential devices in the event of a power failure. Insufficient power is provided for operating power tools on a construction site for example.

Due to the limited capacity of prior known devices for providing portable power, the battery and the inverter for converting the battery power to alternating current are typically located within a common housing for convenience of portability. The mounting configuration of the battery and the inverter within a common housing provide limited access for charging the batteries or for maintenance or variation of any configurations of the device.

Due to the limited power available and the poor mounting configuration of the components in the prior art, prior art portable power devices are generally not suited for continuous use in areas with large power requirements, for example power tools on a construction site.

### SUMMARY OF THE INVENTION

According to one aspect of the invention there is provided a portable power supply device comprising:

at least one battery arranged to supply a direct current;

a battery housing supporting said at least one battery therein;

a power inverter arranged to convert the direct current from said at least one battery to an alternating current;

an inverter housing supporting the power inverter therein;

the inverter housing being arranged to be supported on the battery housing in a working position such that the inverter housing is readily separable from the battery housing;

first connectors on the battery housing in electrical communication with said at least one battery; and

second connectors on the inverter housing in electrical communication with the power converter;

the first and second connectors being arranged to mate such that said at least one battery is in electrical communication with the power inverter in the working position.

By providing batteries within a battery housing which is readily separable from the inverter supported within the inverter housing, using mating electrical connectors between the housings, the portable power supply device of the present invention can accommodate much large capacity batteries while maintaining portability. The separable nature of the inverter housing from the battery housing further permits ready access to the batteries for charging or for interchanging the inverter housing between plural different battery housings which permits one set of batteries to be charged while a different set is in use. Thus, in addition to providing much larger electrical power available, the configuration of the power supply device of the present invention also permits continuous use by allowing simultaneous charging and use of the electrical power. Furthermore charging terminals are mounted externally on the inverter housing for ready access to connect to a charging device in a convenient manner without requiring the housings to be opened or separated in some form. The charging terminals are configured to permit ready connection to a wind or solar generator. Despite the large electrical power available in the device according to the present invention, portability is maintained by supporting the battery housing for rolling movement on the ground and by supporting the inverter housing above the battery housing for relative vertical sliding movement between a working position supported on the battery housing and a released position separated from the battery housing.

Preferably the first and second connectors are arranged for relative sliding movement between a connected position and a released position thereof.

One of the first and second connectors may comprise a male connector and one of the first and second connectors may comprise a female connector. Preferably, the first connectors each comprises a male connector and the second connectors each comprises a female connector.

When the first connectors are located in a top side of the battery housing and the second connectors are located in a bottom side of the inverter housing, preferably the first and second connectors are arranged for mating engagement when the bottom side of the inverter housing is supported in engagement upon the top side of the battery housing.

There may be provided a plurality of first mounts on the battery housing and a plurality of second mounts on the inverter housing in which the first and second mounts are arranged for mating engagement so as to fix position of the inverter housing relative to the battery housing in the working position.

The first and second connectors and the first and second mounts are preferably arranged for relative sliding movement in a vertical direction between a connected position and a released position thereof.

When said at least one battery comprises a plurality of batteries connected to the first connectors in a parallel with one another using connector wires, the connector wires of the batteries are preferably equal in length relative to one another.

When the inverter comprises a plurality of input terminals and a plurality of outer terminals connected to the second connectors using connector wires, the connector wires of the inverter are preferably equal in length relative to one another.

Preferably there is provided a charging terminal connector in parallel with each mating pair of first and second connectors in which the charging terminals are arranged for connection to an external source of electrical current.

The charging terminals are preferably supported externally on one of the housings.

The charging terminals are preferably supported on the inverter housing so as to be readily separable from the battery housing together with the inverter.

There may be provided an external source of electrical current connected to the charging terminals so as to be readily separable therefrom.

The external source of electrical current may be arranged for connection directly to the charging terminals and for connection directly to the first connectors on the battery housing when the inverter housing is separated from the battery housing.

The external source of electrical current may comprise a solar powered generator, or a wind powered generator.

When provided in combination with an auxiliary housing supporting at least one battery therein and having first connectors in electrical communication with said at least one battery so as to be similar in configuration to the battery housing, the inverter housing is preferably arranged to be supported on either one of the auxiliary housing or the battery housing such that the second connectors mate with the respective ones of the first connectors.

There may be provided a charging device arranged to charge said at least one battery of either one of the battery housing or the auxiliary housing when the inverter housing is supported on the other one of the battery housing and the auxiliary housing.

There may be provided a plurality of latch members arranged to be coupled between the inverter housing and the battery housing so as to retain the inverter housing on the battery housing in the working position.

Preferably the battery housing is supported on wheels for rolling movement along the ground and the inverter housing is supported above the battery housing.

The battery housing may comprise a lower portion arranged to support said at least one battery thereon and an upper portion fastened to the lower portion and arranged to support the inverter housing thereon.

The lower portion may comprise a bottom wall supporting said at least one battery thereon and a pair of end walls extending upwardly from the bottom wall at opposing ends of the bottom wall and the upper portion comprises a top wall arranged to span between the end walls spaced above the bottom wall and a pair of side walls extending downwardly from opposing sides of the top wall walls so as to be received between the end walls at opposing sides of the lower portion. The top wall and the side walls of the upper portion may be readily separable together from the bottom wall and the end walls of the lower portion.

The inverter housing may comprise a lower portion comprising a bottom wall supporting the inverter thereon and being arranged for mating connection on the battery housing and an upper portion comprising a top wall and a pair of side walls extending downwardly from opposing sides of the top wall so as to support the top wall spaced above the bottom wall. The top wall and the side walls of the upper portion may be readily separable together from the lower portion.

There may be provided a plurality of second connectors on the battery housing in electrical communication with said at least one battery in which the second connectors on the battery housing are arranged to be coupled to the first connectors of a second battery housing of like configuration such that both battery housings can be connected in parallel with the inverter housing. In this instance, the first connectors of each battery housing are preferably located in a top side of the battery housing, the second connectors of each battery housing are preferably located in a bottom side of the battery housing and the second connectors of the inverter housing are preferably located in a bottom side of the inverter housing such that the first connectors of a first one of the battery housings are arranged to be aligned for mating connection with the second connectors of the inverter housing when the inverter housing is stacked thereon and such that the first connectors of a second one of the battery housings are arranged to be aligned for mating connection with the second connectors of the first one of the battery housings when the first one of the battery housings is stacked on the second one of the battery housings.

The battery housing may comprise a pair of mounting channels extending along opposing sides of the battery housing to depend downwardly from a bottom wall of the battery housing. Preferably the pair of mounting channels are arranged to receive a top end of a second battery housing of like configuration therebetween so as to be arranged to align the battery housing relative to the second battery housing of like configuration in a stacked configuration of the battery housings.

There may be provided a wheel mounting aperture in each of the mounting channels arranged to rotatably mount a wheel on the battery housing so as to support the battery housing for rolling movement along the ground.

When the first connectors on the battery housing comprise a negative first connector in a top side of the battery housing in communication with a negative terminal of said at least one battery and a positive first connector in the top side of the battery housing in communication with a positive terminal of said at least one battery, the second connectors on the inverter housing may comprise a positive second connector and a negative second connector in a bottom side of the inverter housing in which the connectors are aligned so as to be arranged for mating connection when the inverter housing is stacked upon the battery housing.

In the illustrated embodiment, each of the first connectors comprises a conductive contact element supported in respective vertical channels in an insulated housing by a respective stop member of plastic material in which the stop member of the negative first connector is smaller than the stop member of the positive first connector such that the negative first connector is arranged to be releasable from the respective insulated housing prior to the positive first connector responsive to high temperature resulting from a high current flow through the conductive contact element.

Some embodiments of the invention will now be described in conjunction with the accompanying drawings in which:

### BRIEF DESCRIPTION OF THE DRAWINGS

FIG. 1 and FIG. 2 are perspective views of a first embodiment of the portable power supply device.

FIG. 3 is an exploded perspective view of the battery housing and the inverter housing of the device according to FIGS. 1 and 2.

FIG. 4 is a schematic representation of the connection between the batteries and the inverter in the device of FIG. 1.

FIG. 5 is a schematic representation of an alternate mounting configuration of the batteries in the embodiment of FIG. 1.

FIG. 6 is a perspective view of a second embodiment of the portable power supply device.

FIG. 7 is an exploded view of the housings of the device according to

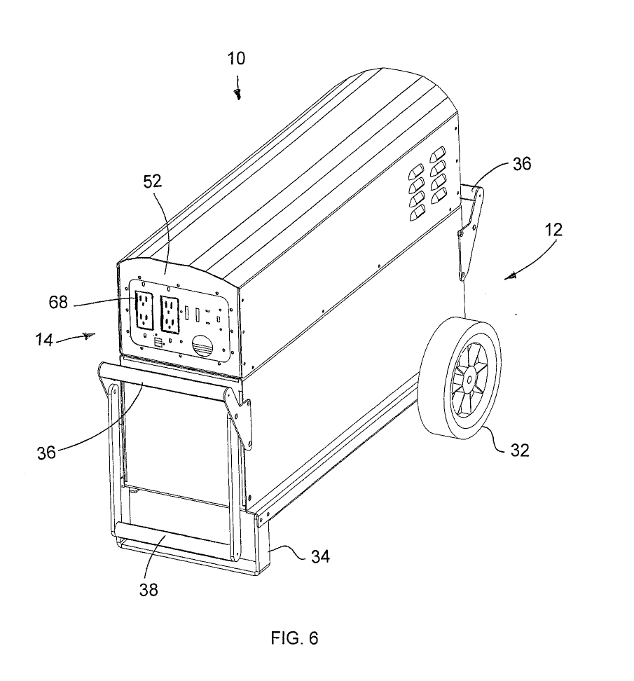

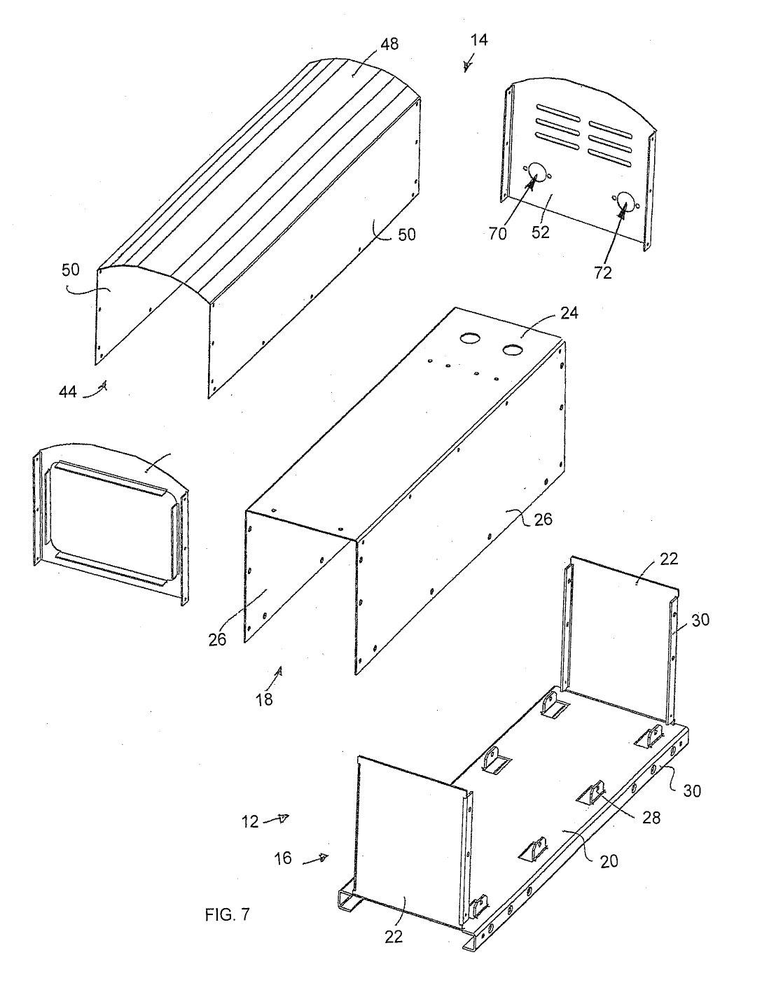

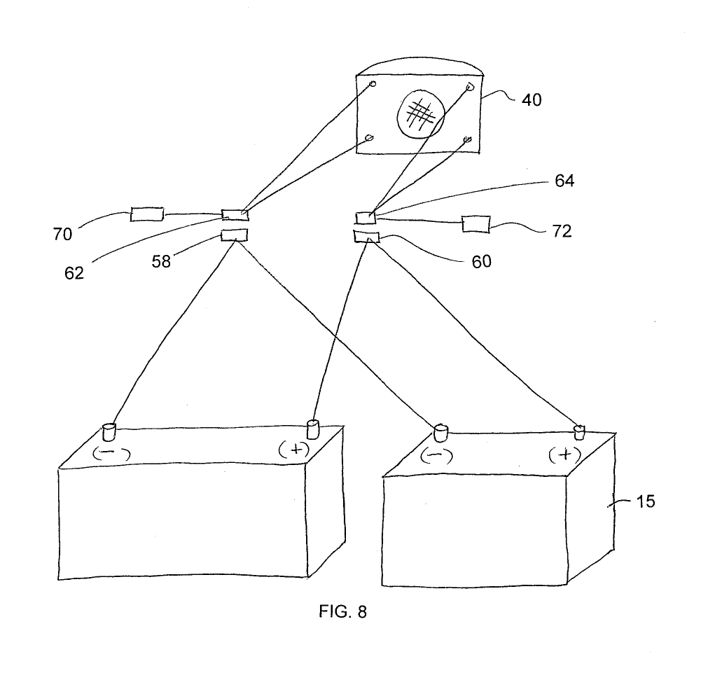

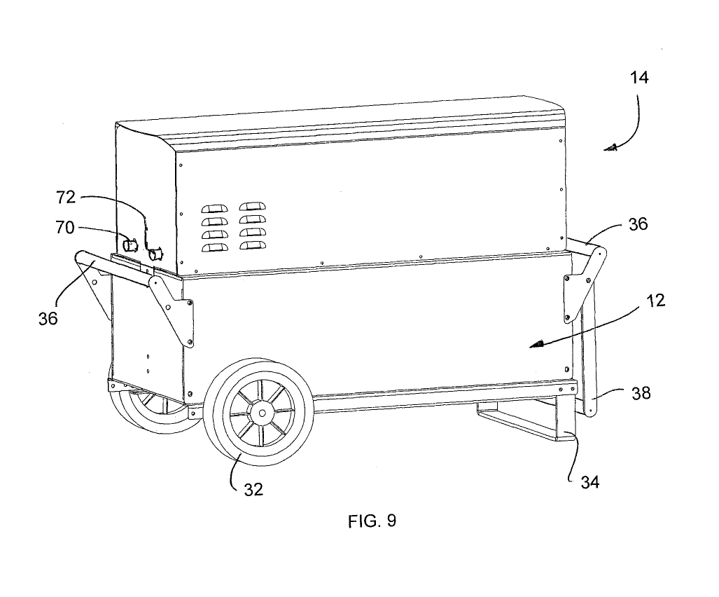

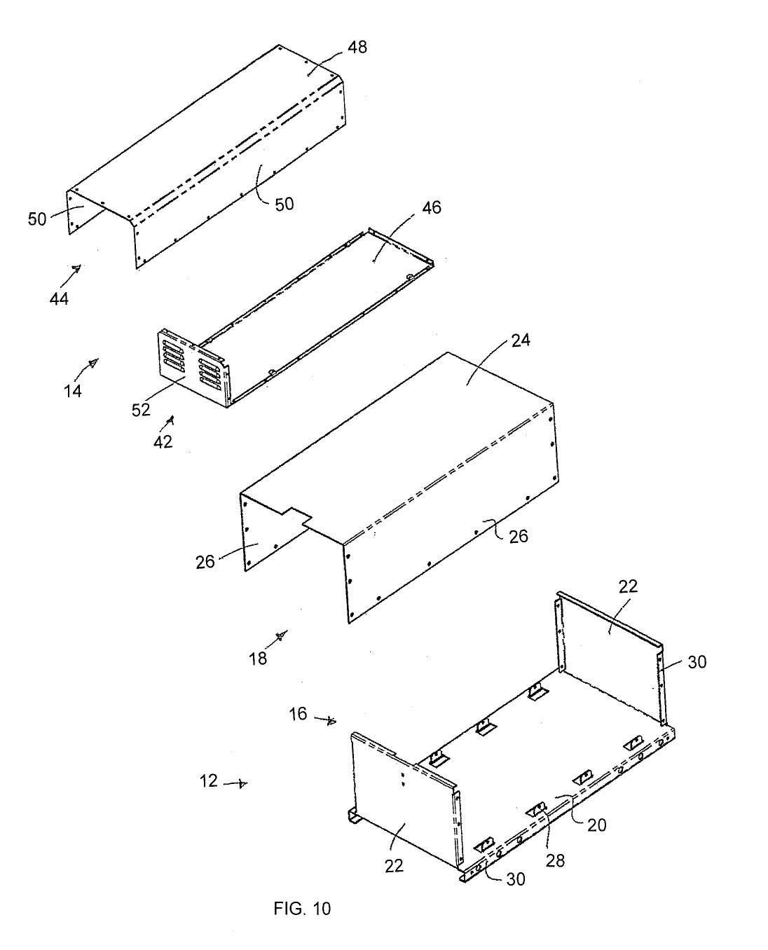

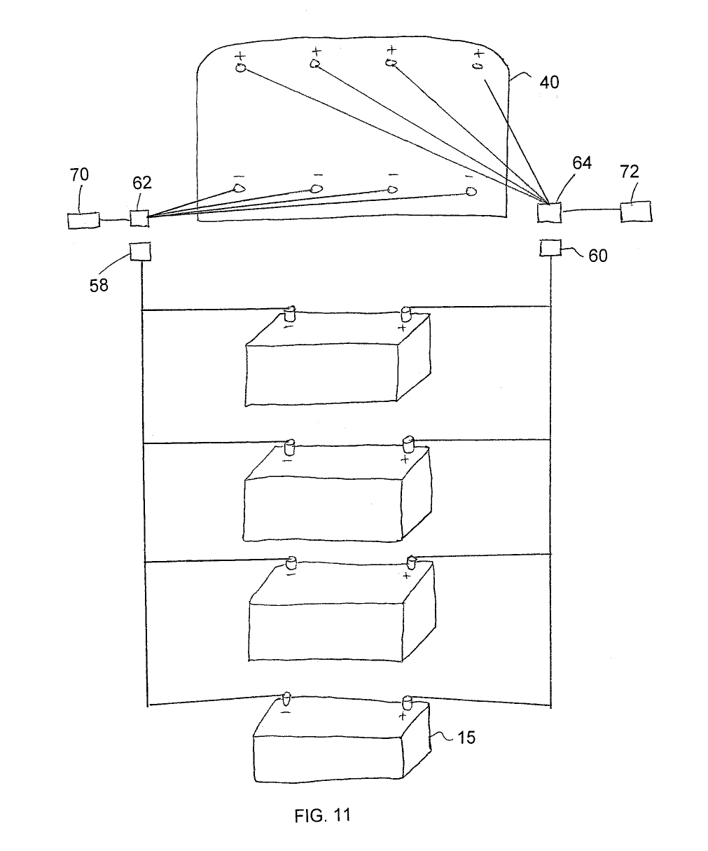

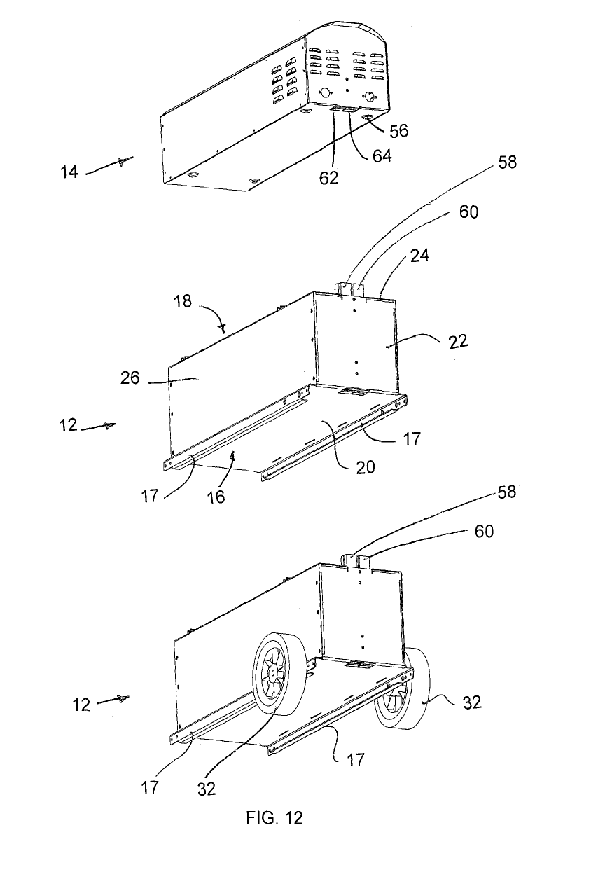

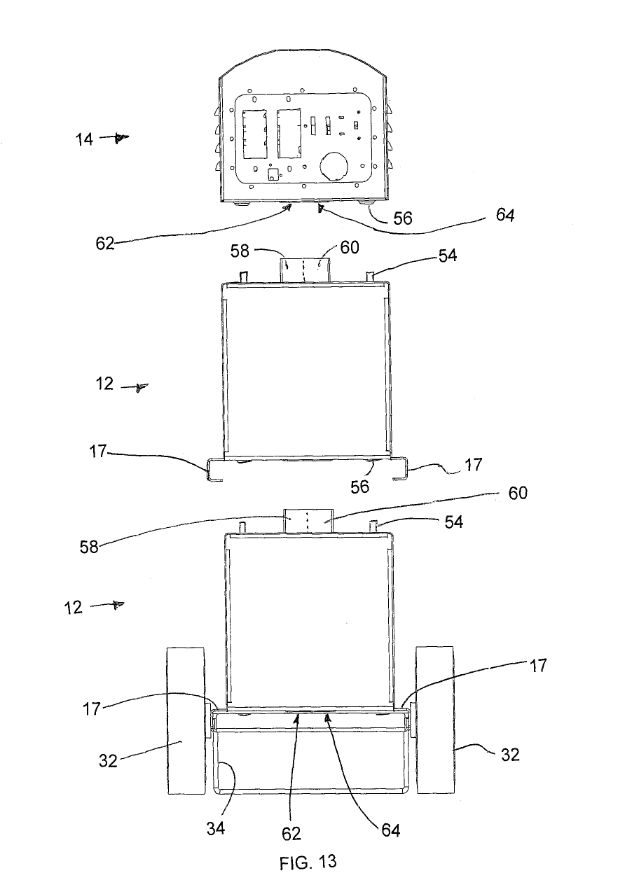

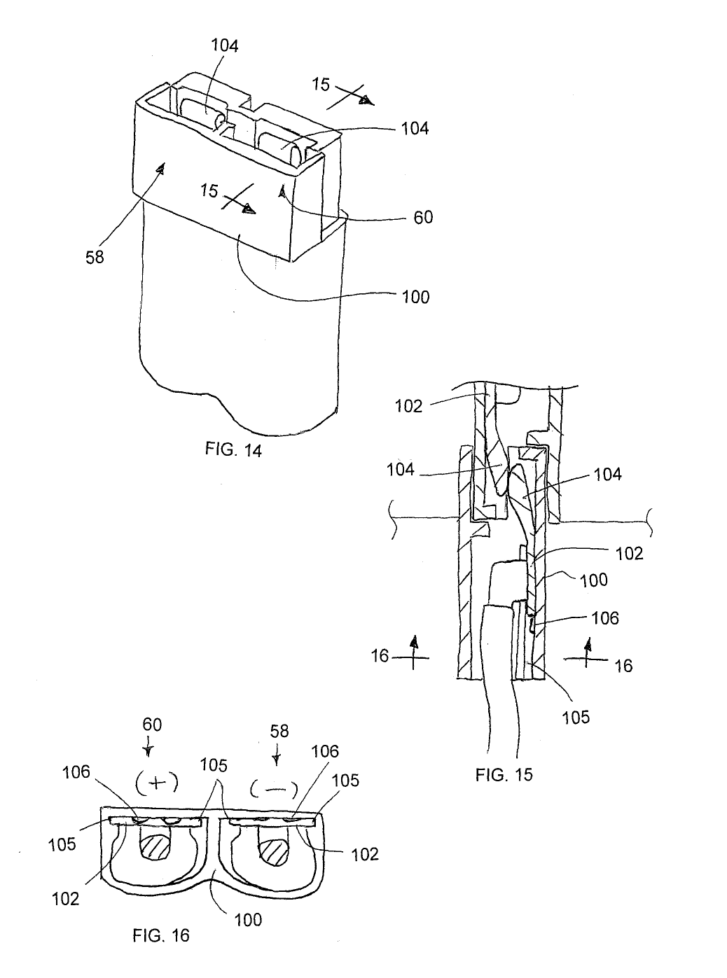

FIG. 6.

FIG. 8 is a schematic representation of the connection between the batteries and the inverter in the device according to FIG. 6.

FIG. 9 is a perspective view of a further embodiment of the portable power supply device.

FIG. 10 is an exploded perspective view of the housings of the device according to FIG. 9.

FIG. 11 is a schematic representation of the batteries connected to the inverter in the device of FIG. 9.

FIG. 12 and FIG. 13 are an exploded perspective view and an exploded end elevational view of a pair of battery housings to be stacked relative to one another below the inverter housing.

FIG. 14 is a perspective view of the positive and negative first connectors of the battery housing.

FIG. 15 is a sectional view along the line 15-15 of FIG. 14.

FIG. 16 is a sectional view along the line 16-16 of FIG. 15.

In the drawings like characters of reference indicate corresponding parts in the different figures.

### DETAILED DESCRIPTION

Referring to the accompanying figures there is illustrated a portable power supply device generally indicated by reference numeral 10. The device 10 is particularly suited for use in areas where no electrical grid power is available.

Although various embodiments of the device 10 are shown in the accompanying figures, the common features of all of the embodiments will first be described herein.

The device 10 generally comprises a battery housing 12 arranged to be supported for rolling movement on the ground and an inverter housing 14 which is supported on the battery housing so as to be readily separable therefrom.

The battery housing 12 is arranged to receive a plurality of batteries therein, for example automotive type batteries arranged to supply 12 volts of direct current. The housing 12 is rectangular in shape and includes a lower portion 16 and an upper portion 18 which receive the batteries 15 therebetween. The lower portion comprises a rectangular bottom wall 20 arranged to span generally horizontally between a pair of opposing ends supporting end walls 22 integrally with the bottom wall to extend vertically and perpendicularly upwardly therefrom. The end walls 22 are parallel to one another and are spaced apart at opposing ends of the housing.

The upper portion 18 comprises a top wall 24 which is also generally rectangular so as to be similar in dimension to the bottom wall 20 to span horizontally between the end walls 22 parallel and spaced above the bottom wall 20. The upper portion also includes side walls 26 of the housing which are integral with the top wall 24 and are arranged to extend downwardly therefrom along opposing longitudinally extending sides of the top wall 24 so as to fit between the end walls 22 when the upper and lower portions of the battery housing when assembled. Together the upper and lower portions fully enclose a hollow interior of the battery housing receiving the batteries 15 therein.

A plurality of battery mounts 28 are mounted in the bottom wall of the lower portion at spaced apart locations so as to be arranged to receive respective ones of the batteries 15 between opposed pairs of the mounts to permit fastening of the batteries to the bottom walls of the battery housing. Once the batteries are mounted within the lower portion of the battery housing, the upper portion is fastened to the lower portion by fasteners extending through cooperating apertures in fastener flanges 30 formed along the edges of the bottom wall and the end walls of the lower portion which are arranged to be overlapped by corresponding edges of the upper portion of the housing.

The lower portion 16 of the housing includes a pair of mounting channels 17 supported to extend along opposing sides of the bottom wall between the opposing end walls. Each mounting channel is generally C-shaped in cross-section and is mounted integrally with the bottom wall such that each channel extends downwardly and outwardly from the respective side of the bottom wall. The two opposed mounting channels thus depend downwardly beyond the bottom wall, spaced apart from one another by a space therebetween which corresponds to the width of the battery housing between the opposing sides at either of the top or bottom ends of the side walls. The battery housing is thus arranged to be stacked on another battery housing of like configuration with the depending mounting channels extending downwardly along opposing side walls of the other battery housing to assist in retaining the battery housings in stacked alignment with one another.

The mounting channels include wheel mounting apertures formed therein and arranged to be coupled to respective wheel axles such that the battery housing can be supported on wheels 32 for rolling movement along the ground in the longitudinal direction of the housing between the opposing ends of the housing.

The wheels are situated at one end of the battery housing opposite a pair of legs 34 arranged to support the bottom wall in the horizontal orientation. The legs 34 are also arranged to be mounted onto respective mounting apertures in the mounting channels of the battery housing.

Handlebars 36 are provided to span laterally across each of the opposing ends of the battery housing spaced outwardly from the end walls 22 adjacent the top end of the battery housing. The handlebar 36 situated opposite the wheels includes an additional folding handle 38 which is hinged at an inner end on the handlebar for pivotal movement between a collapsed position extending downwardly from the handlebar along the respective end wall approximately a full height of the battery housing, and a transport position in which the folding handle extends longitudinally outward for gripping by hands of a user.

The top wall 24 of the battery housing is generally flat and supported in a horizontal orientation so as to be well suited to support the inverter housing 14 thereon.

The inverter housing 14 receives a power inverter 40 therein which is arranged to convert the direct current from the batteries to an alternating current. The power inverter 40 includes its own sealed integral housing that is sealed about the internal electrical components in which the sealed integral housing has suitable cooling fins formed thereon. The surrounding inverter housing 14 is spaced outwardly from the integral housing of the inverter 40 to provide a cooling spaced about the cooling fins of the integral housing. A cooling fan can be mounted in the space between the integral housing of the inverter 40 and the surrounding inverter housing 14 to direct a flow of cooling air through the housing 14 to cool the fins of the integral housing of the inverter 40.

Similar to the battery housing, the inverter housing includes a lower portion 42 and an upper portion 44 which can be assembled together to fully enclose a hollow interior of the inverter housing which receives the power inverter 40 therein.

The lower portion 42 comprises a bottom wall 46 which is generally rectangular and supported to span horizontally in abutment flat against the top wall of the battery housing therebelow in a mounted position.

The upper portion 44 of the inverter housing comprises a top wall 48 which is similarly generally rectangular in shape to span substantially a fully length of the bottom wall at a location spaced thereabove. Side walls 50 are formed integrally with the top wall 48 to extend in a longitudinal direction along opposing sides of the top wall to depend downwardly therefrom for joining with the bottom wall of the lower portion when the housing is assembled.

A pair of end walls 52 enclose the opposing ends of the inverter housing are parallel and spaced apart to span vertically between the top and bottom walls and to span laterally between the opposed side walls. The end walls 52 are suitably vented to permit airflow through the inverter housing to cool the electrical components of the power inverter under operation of cooling fans of the inverter. Suitable access is also provided through the end walls 52 to provide access to the power inverter for access to the alternating current supplied by the power inverter, for monitoring various characteristics of the inverter and for providing access to various controls of the inverter.

The inverter housing is supported above the battery housing by a plurality of first mounts 54 on the top wall of the battery housing which matingly engage with second mounts 56 on the bottom wall of the inverter housing. Each of the first mounts 54 comprises a vertical peg arranged to be received within a corresponding one of the second mounts which comprises a socket formed at the bottom side of the inverter housing. The first mounts 54 are provided at each of the four corners of the top wall and at one or more intermediate positions therebetween. The male configuration of the first mounts 54 are received within the female second mounts 56 by vertical sliding movement of the inverter housing relative to the battery housing so that the inverter housing is supported thereon by sliding the inverter housing down overtop of the upright pegs on the top wall of the battery housing. The mating first and second mounts thus serve to locate the inverter housing relative to the battery housing and retain the relative positions thereof. Other suitable mating connectors which retain the inverter housing relative to the battery housing can be used in place of the mounts 54 and 56.

A similar arrangement of first and second mounts 54 and 56 can also be provided for connection between a stacked pair of battery housings to retain the battery housings relative to one another.

Further support between the inverter housing and the battery housing is provided by suitable connectors between the battery housing and the inverter housing which provide electrical communication between the batteries and the power inverter. More particularly the battery housing comprises a negative first connector 58 and a positive first connector 60 comprising male connectors extending upwardly from the top side of the battery housing adjacent one end thereof. The first connectors are fixed relative to the lower portion of the battery housing by being fixed to one of the end walls to extend upwardly through a suitable cutaway opening of the top wall of the housing. The negative and positive first connectors are connected to the negative and positive terminals of the respective batteries 15 in a parallel configuration in which each of the batteries communicates with the respective first connector by an equal length of conductive wire so that the resistance of each is substantially identical to balance power of the batteries relative to one another. An additional battery management system may further be provided to ensure balanced voltages among the batteries.

The inverter housing comprises a negative second connector 62 and a positive second connector 64 in the form of female socket connectors recessed into the bottom wall of the inverter housing adjacent one end thereof so as to be suited for alignment with the respective first connectors when the inverter housing is supported on the battery housing in the working position. The negative and positive connectors are connected to a plurality of negative and positive input terminals of the power inverter 40 using a plurality of conductive wires which are all equal in length relative to one another so as to have equal resistances.

Each battery housing 12 also comprises a negative second connector 62 and a positive second connector 64 in the form of female socket connectors recessed up and inwardly into the bottom wall of the battery housing adjacent the same end as the first connectors. In this manner, the second connectors are suited for alignment with the respective first connectors of another battery housing onto which the battery housing is stacked. The positive and negative terminals of the batteries of each battery housing are connected in parallel to respective ones of each of the first and second connectors of the battery housing the plurality of conductive wires which are all equal in length relative to one another so as to have equal resistances. When stacking plural battery housings as shown in FIGS. 12 and 13, all of batteries are effectively coupled in parallel with one another between the terminals of the inverter housing by the interconnected stacking of the first and second connectors of the various housings.

In each instance, the first and second connectors are arranged to mate with one another by a relative vertical sliding movement of the upper housing (typically the inverter housing or a stacked battery housing) relative to the lower housing (typically the primary or a secondary battery housing) for connection with one another so that the batteries communicate with the inverter housing through the same relative sliding movement as the connection between the first and second mounts which retain the inverter housing on the battery housing.

To further secure the inverter housing on the battery housing in the working position, and the battery housings relative to one another if plural are stacked, a plurality of latches 66 are provided which are coupled between the inverter housing and the battery housing in the working position. The latches 66 are supported externally on the housing so that two latches are situated at spaced apart positions along each longitudinally extending side of the device. Each latch communicates between a respective side wall of the battery housing and a respective side wall of the inverter housing. When the latches are in a secured position, the inverter housing is prevented from being separated from the battery housing. By readily releasing the latches, the inverter housing is separated from the battery housing simply by sliding vertically upward to disconnect the first and second mounts and the first and second connectors relative to one another.

In the mounted position with the connectors and the mounts mated with one another, the batteries supply direct current voltage to the input terminals of the power inverter which then converts the direct current to an alternating current which is output through any one of a plurality of outlet receptacles 68 at one end of the inverter for access through a respective one of the end walls 52 of the inverter housing.

A negative charging terminal 70 and a positive charging terminal 72 are also situated at an end of the inverter for access through a respective one of the end walls of the inverter housing. The charging terminals are connected in parallel with respective ones of the negative and positive second connectors 62 and 64 of the inverter housing for charging the batteries through the inverter when a suitable charging device is connected to the charging terminals. The charging terminals are situated externally on the stackable inverter housing for ready access without any disassembly of the housing being required. The charging terminals are supported on the inverter housing so as to be readily separated from the batteries and the battery housing together with the inverter housing.

The charging device typically comprises an external source of electrical current which is connected to the charging terminal so as to be readily separable therefrom when not charging. Suitable insulating caps are provided for covering the charging terminals when not in use. Preferred charging devices for use with the present invention include solar or wind powered generators. In alternate configurations, the charging device may comprise a connection to grid power or to a gas powered internal combustion engine generator. When using a gas powered generator, typically a bank of several power supply devices 10 can be connected in parallel and charged simultaneously. The charging device may be arranged for connection directly to the charging terminals on the inverter housing, or alternatively when the inverter housing is separated from the battery housing, the charging device may be connected directly to the first connectors of the battery housing. In this arrangement an auxiliary battery housing may be provided which is identical in configuration to the first battery housing so that each has a similar configuration of connectors and mounts to which the inverter housing can be connected. The two battery housings can thus be interchangeable with one another so that one battery housing can be connected to the charging device for charging the batteries thereof while the other is being used by connection to the inverter. When power is depleted from the battery housing connected to the inverter, the battery housings can be interchanged with one another for recharging the depleted batteries while making use of the batteries which have been freshly charged.

In preferred embodiment, the positive and negative first connectors and the positive and negative second connectors which electrically interconnect the housings when stacked are provided with suitable means to allow the negative connector of the battery housings to become separated more readily than the positive connector in the event of a power surge or short circuit.

Each of the first and second connectors comprises an insulated housing 100 formed of insulating material which is arranged for vertical sliding mating connection with the insulated housing of the corresponding connector to which it is mated when the housings are stacked. Each of the connectors further comprises a contact element of conductive material supported within the insulated housing for electrical contact with the contact element of the connector to which it is mated. Each of the contact elements comprises a base portion 102 fixed within an interior of the insulated housing for electrical contact with the internal wires of the housing and a contact portion 104 which is sprung relative to the base portion and arranged for contact with the contact portion 104 of another connector to which it is mated.

The base portion comprises a flat flange member slidably received along opposing edges thereof in respective vertical channels 105 formed in the insulated housing which are open to an inner end of the insulated housing within an interior of the housing. The base portions are only prevented from sliding out through the open end of the insulated housing by respective stop members 106 of plastic insulating material integral with the material of the insulated housing which project inwardly from an inner surface of the insulated housing to overlap a free end of the base portion.

The stop members of the negative first connector of the battery housings are smaller than the stop members of the corresponding positive first connector. In this manner, high temperature resulting from a high current flow through the conductive contact element, for example due to a power surge or short circuit, will cause the stop member of the negative first connector to melt first. Because the channels which support the base portion are open to a bottom interior end of the insulated housing, the melting of the stop members causes the contact element to fall down into the interior of the battery housing so as to electrically disconnected the contact elements from one another. More particularly, the negative first connector is arranged to be releasable from the respective insulated housing prior to the positive first connector.

In each embodiment, the inverter is arranged for regulating a fluctuating input to provide a pure modified sin wave phase adjusted output. Various configurations of the different embodiments result in differing input and output characteristics of the portable power supply device as described in the following.

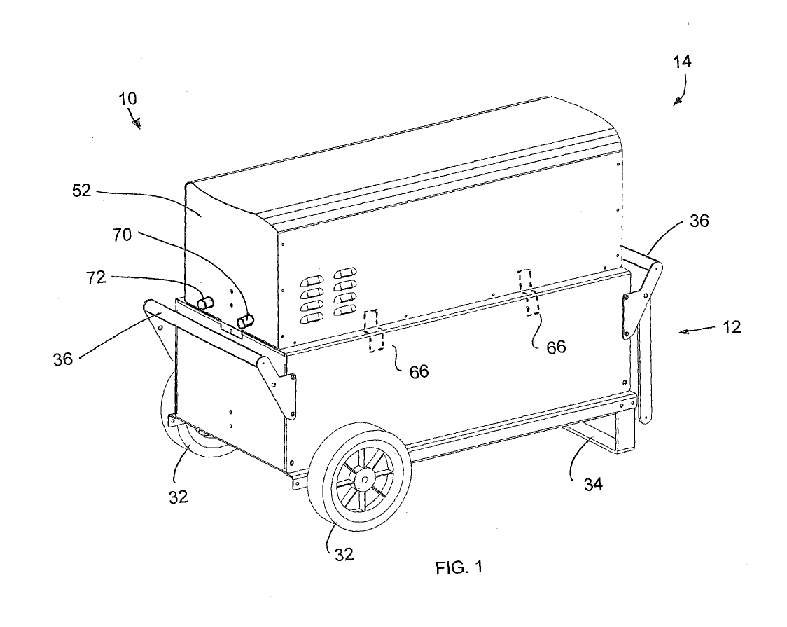

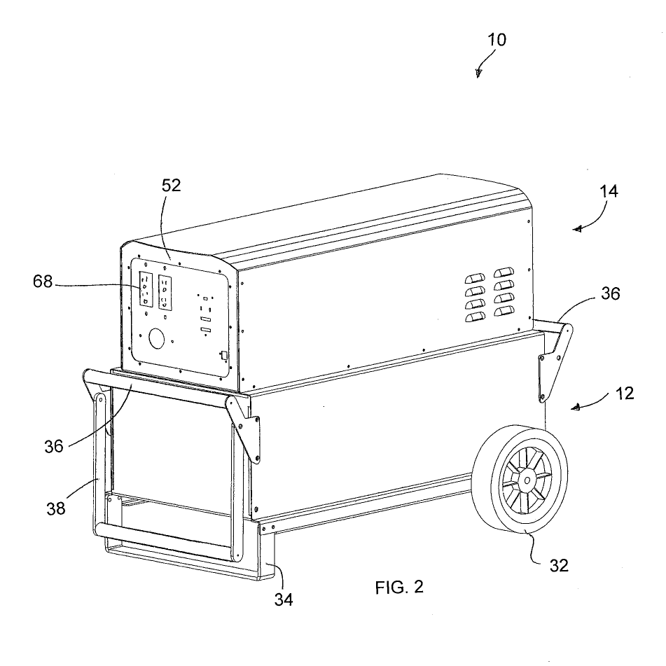

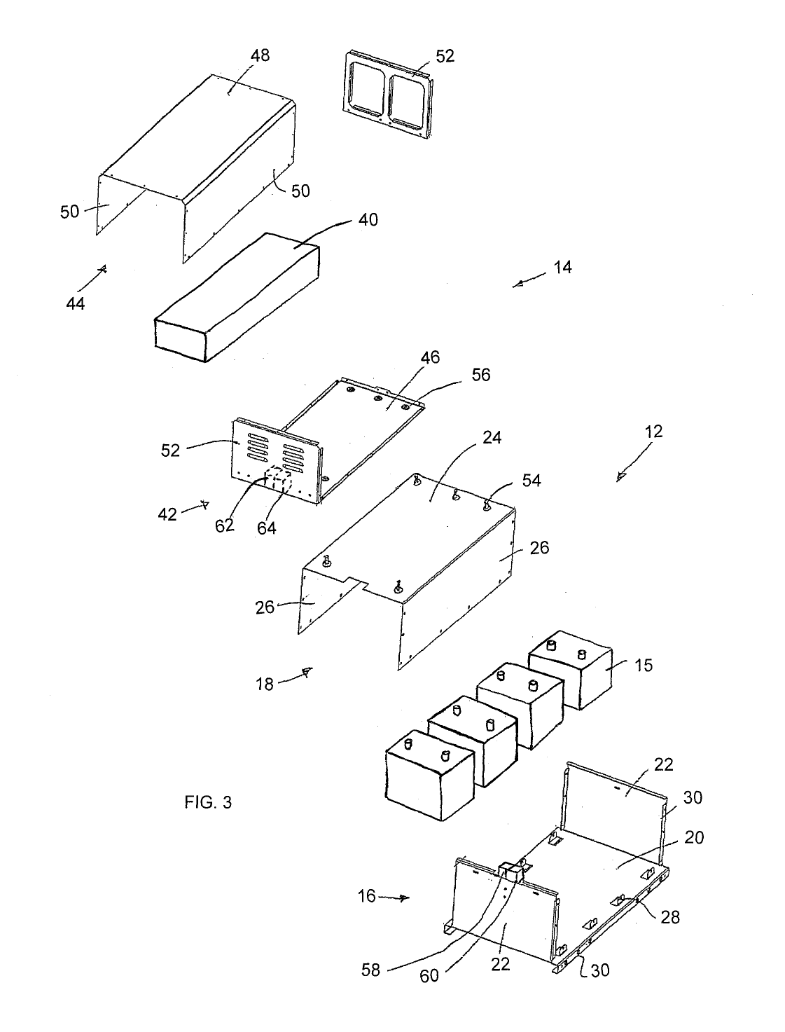

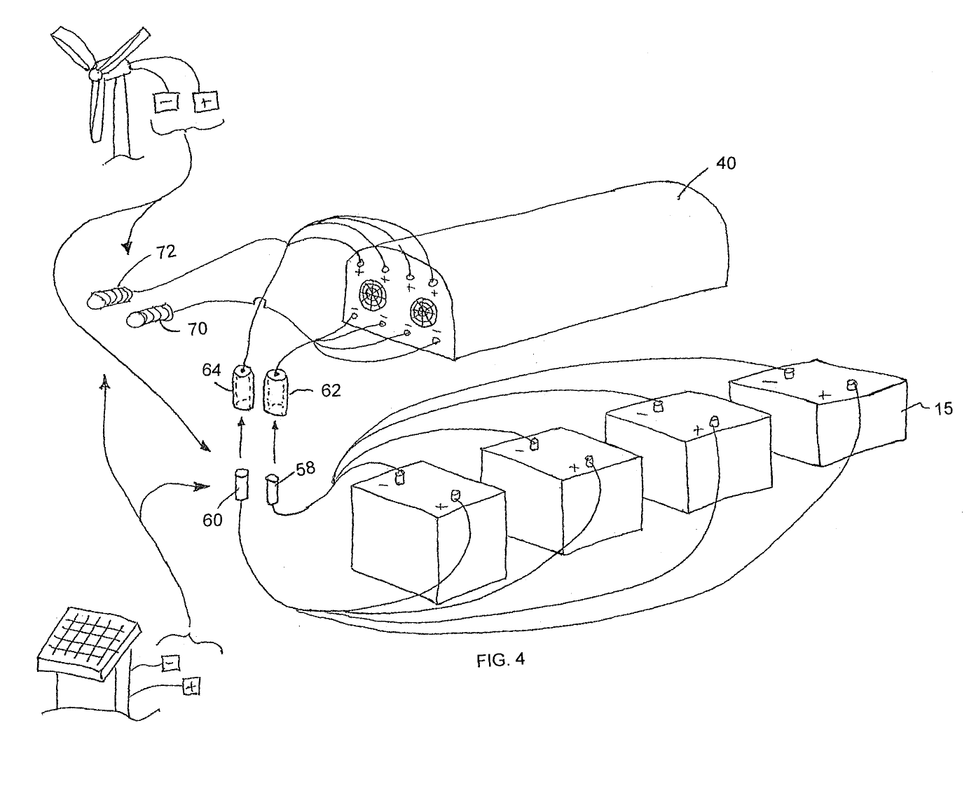

As shown in FIGS. 1 through 4, four 12 volt batteries are connected so as to be each in parallel with the other batteries for supplying power to an inverter rated at 8000 watts running at an output of 110 volts of alternating current. The electrical conductors connected between each connected pair of terminals may comprise two wires connected in parallel so that the connectors are maintained cooler and are arranged to accommodate higher wattages for power tools and the like.

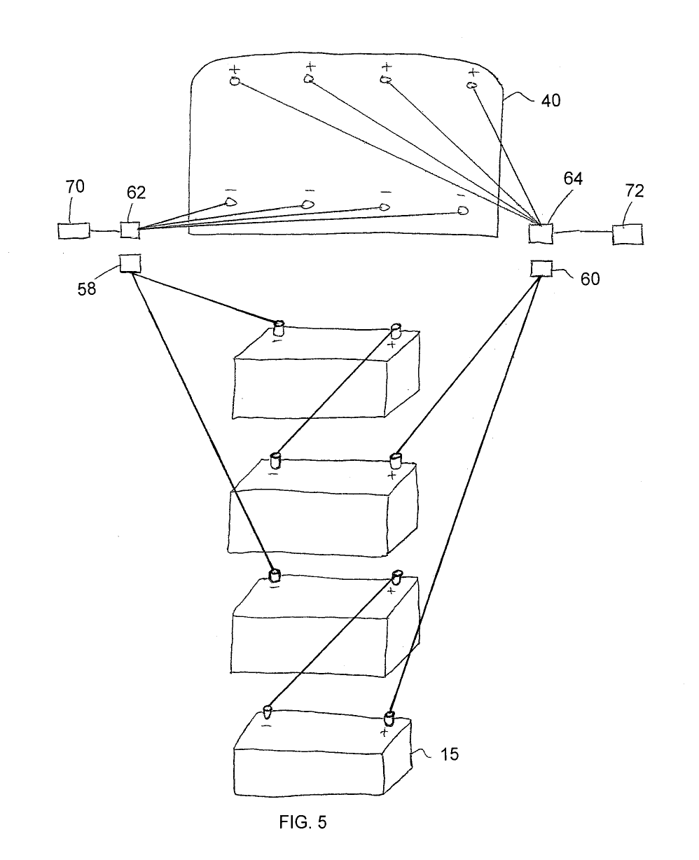

As shown in an alternate configuration of the batteries in FIG. 5, the four 12 volt batteries may instead be connected so that two pairs of batteries in series with one another are connected in parallel which in turn leads to 24 volts of direct current being supplied to the input terminals of the power inverter. To accommodate the larger inverter capable of 8000 watts running, the inverter housing is substantially the same width and length as the battery housing upon which it is supported when the battery housing supports four batteries therein.

Alternatively, in a lower power rated embodiment, the battery housing may instead be arranged to accommodate two 12 volt batteries connected in parallel with one another to the input terminals of a power inverter rated at 5000 watts running. The inverter housing in this instance again spans substantially the full width and length of the battery housing, however both the inverter housing and the battery housing are much narrower than in the embodiment of FIGS. 1 through 5.

As shown in FIGS. 9 through 11, in a further embodiment, four batteries may again be provided within the battery housing similar to the first embodiment, however a lower power rated inverter rated at 7000 watts running is connected to the batteries so that a smaller inverter housing is required as compared to the first embodiment. Accordingly the inverter housing spans the full length of the battery housing, but is narrower than the battery housing in a lateral direction.

In preferred embodiments, the inverter includes a volt meter and an amp meter at one end thereof which is accessible to the operator through a respective one of the end walls of the inverter housing. In the preferred embodiment the batteries comprise valve regulated lead acid batteries having absorbed glass mat technology with gas recombination greater than 99%. The device operates at a lower internal pressure with no watering of the batteries ever being needed. The inverter housing can also be provided with a USB serial port and suitable electronics for recording and transmitting various operating characteristics of the inverter housing to an external computer connected to the USB serial port by a suitable connection.

The present invention uses leading edge technology to generate the Vac output digitally. It uses a built in automatic control program. The ac output uses a built-in pulse control circuit so that minor fluctuations in the output are sensed and corrected. Even during sudden power variations, equipment connected to the inverter output is protected from spikes in the voltage. Even when input Voltage is varying or high, the output is protected by the PWM design of the device 10.

Other particulars of the device 10 are noted in the following. The device can produce 220 Vac power by using 24 Vdc input power sources. The device includes a product switch which comprises a multiple 75 Amp circuit breaker. If the output is exceeded, the breaker will POP and you will have to manually reset it. A main power switch of the device 10 is configured so that when this is turned OFF, the device is off and when turned ON the device is on. A green ON Lamp will illuminate when ON and 110 or 220Vac will be available at the outlet and terminal block. A digital LED display is arranged to indicate Voltage levels of the batteries. A load indicator indicates when the device is in use and the current percentage of maximum permissible load. A red overload lamp is lit whenever there is a fault, for example Overload, Over Temperature, Faulty Power Inverter, Low or High dc battery Voltage, etc. The device is supplied with 2 standard ac outlets and 1 terminal block for direct connection. Either or both may be used simultaneously. A direct connect terminal block has been provided for easy connection. The protect switch and main power switch need to be off prior to making any connection. An earth terminal should be wired to a ground point for your safety, and not used for E-P.O.D functionally. It should be connected to vehicle frame, water pipe, ground pipe or any other valid grounding point. The inverter includes automatic cooling fans which are thermally controlled and will turn on automatically when needed.

In further embodiments, the device may provide output power from the inverter which is rated up to 10,000 Watts of continuous power or even greater output power depending upon the size of the inverter. Also the output power can be rated at 230 volts at a cycle of 50 Hertz for use in Europe, or at various other ratings for use according to the local grid power available in any country of use.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A portable power supply device comprising:
at least one battery arranged to supply a direct current;
a battery housing supporting said at least one battery therein;
a power inverter arranged to convert the direct current from said at least one battery to an alternating current;
an inverter housing supporting the power inverter therein;
the inverter housing being arranged to be supported on the battery housing in a working position such that the inverter housing is readily separable from the battery housing;
first connectors on the battery housing in electrical communication with said at least one battery; and
second connectors on the inverter housing in electrical communication with the power converter;
the first and second connectors being arranged to mate such that said at least one battery is in electrical communication with the power inverter in the working position.

2. The device according to claim 1 wherein the first and second connectors are arranged for relative sliding movement between a connected position and a released position thereof.

3. The device according to claim 1 wherein one of the first and second connectors comprises a male connector and one of the first and second connectors comprises a female connector.

4. The device according to claim 3 wherein the first connectors each comprises a male connector and the second connectors each comprises a female connector.

5. The device according to claim 1 wherein the first connectors are located in a top side of the battery housing and the second connectors are located in a bottom side of the inverter housing, the first and second connectors being arranged for mating engagement when the bottom side of the inverter housing is supported in engagement upon the top side of the battery housing.

6. The device according to claim 1 wherein there is provided a plurality of first mounts on the battery housing and a plurality of second mounts on the inverter housing, the first and second mounts being arranged for mating engagement so as to fix position of the inverter housing relative to the battery housing in the working position.

7. The device according to claim 6 wherein the first and second connectors and the first and second mounts are arranged for relative sliding movement in a vertical direction between a connected position and a released position thereof.

8. The device according to claim 1 wherein said at least one battery comprises a plurality of batteries connected to the first connectors in a parallel with one another using connector wires, the connector wires of the batteries being equal in length relative to one another.

9. The device according to claim 1 wherein the inverter comprises a plurality of input terminals and a plurality of outer terminals connected to the second connectors using connector wires, the connector wires of the inverter being equal in length relative to one another.

10. The device according to claim 1 wherein there is provided a charging terminal connector in parallel with each mating pair of first and second connectors, the charging terminals being arranged for connection to an external source of electrical current.

11. The device according to claim 10 wherein the charging terminals are supported externally on one of the housings.

12. The device according to claim 10 wherein the charging terminals are supported on the inverter housing so as to be readily separable from the battery housing together with the inverter.

13. The device according to claim 10 in combination with an external source of electrical current connected to the charging terminals so as to be readily separable therefrom.

14. The device according to claim 13 wherein the external source of electrical current is arranged for connection directly to the charging terminals and for connection directly to the first connectors on the battery housing when the inverter housing is separated from the battery housing.

15. The device according to claim 13 wherein the external source of electrical current comprises a solar powered generator.

16. The device according to claim 13 wherein the external source of electrical current comprise a wind powered generator.

17. The device according to claim 1 in combination with an auxiliary housing supporting at least one battery therein and having first connectors in electrical communication with said at least one battery so as to be similar in configuration to the battery housing, the inverter housing being arranged to be supported on either one of the auxiliary housing or the battery housing such that the second connectors mate with the respective ones of the first connectors.

18. The device according to claim 17 wherein there is provided a charging device arranged to charge said at least one battery of either one of the battery housing or the auxiliary housing when the inverter housing is supported on the other one of the battery housing and the auxiliary housing.

19. The device according to claim 1 wherein there is provided a plurality of latch members arranged to be coupled between the inverter housing and the battery housing so as to retain the inverter housing on the battery housing in the working position.

20. The device according to claim 1 wherein the battery housing is supported on wheels for rolling movement along the ground and the inverter housing is supported above the battery housing.

21. The device according to claim 1 wherein the battery housing comprises a lower portion arranged to support said at least one battery thereon and an upper portion fastened to the lower portion and arranged to support the inverter housing thereon.

22. The device according to claim 21 wherein the lower portion comprises a bottom wall supporting said at least one battery thereon and a pair of end walls extending upwardly from the bottom wall at opposing ends of the bottom wall and the upper portion comprises a top wall arranged to span between the end walls spaced above the bottom wall and a pair of side walls extending downwardly from opposing sides of the top wall walls so as to be received between the end walls at opposing sides of the lower portion, the top wall and the side walls of the upper portion being readily separable together from the bottom wall and the end walls of the lower portion.

23. The device according to claim 1 wherein the inverter housing comprises a lower portion comprising a bottom wall supporting the inverter thereon and being arranged for mating connection on the battery housing and an upper portion comprising a top wall and a pair of side walls extending downwardly from opposing sides of the top wall so as to support the top wall spaced above the bottom wall, the top wall and the side walls of the upper portion being readily separable together from the lower portion.

24. The device according to claim 1 wherein there is provided a plurality of second connectors on the battery housing in electrical communication with said at least one battery, the second connectors on the battery housing being arranged to be coupled to the first connectors of a second battery housing of like configuration such that both battery housings can be connected in parallel with the inverter housing.

25. The device according to claim 24 wherein the first connectors of each battery housing are located in a top side of the battery housing, the second connectors of each battery housing are located in a bottom side of the battery housing and the second connectors of the inverter housing are located in a bottom side of the inverter housing such that the first connectors of a first one of the battery housings are arranged to be aligned for mating connection with the second connectors of the inverter housing when the inverter housing is stacked thereon and such that the first connectors of a second one of the battery housings are arranged to be aligned for mating connection with the second connectors of the first one of the battery housings when the first one of the battery housings is stacked on the second one of the battery housings.

26. The device according to claim 1 wherein the inverter housing is arranged to be supported on a top side of the battery housing and wherein the battery housing comprises a pair of mounting channels extending along opposing sides of the battery housing to depend downwardly from a bottom wall of the battery housing, the pair of mounting channels being arranged to receive a top end of a second battery housing of like configuration therebetween so as to be arranged to align the battery housing relative to the second battery housing of like configuration in a stacked configuration of the battery housings.

27. The device according to claim 26 wherein there is provided a wheel mounting aperture in each of the mounting channels arranged to rotatably mount a wheel on the battery housing so as to support the battery housing for rolling movement along the ground.

28. The device according to claim 1 wherein the first connectors on the battery housing comprise a negative first connector in a top side of the battery housing in communication with a negative terminal of said at least one battery and a positive first connector in the top side of the battery housing in communication with a positive terminal of said at least one battery and wherein the second connectors on the inverter housing comprise a positive second connector and a negative second connector in a bottom side of the inverter housing, the connectors being aligned so as to be arranged for mating connection when the inverter housing is stacked upon the battery housing.

29. The device according to claim 28 wherein each of the first connectors comprises a conductive contact element supported in respective vertical channels in an insulated housing by a respective stop member of plastic material, the stop member of the negative first connector being smaller than the stop member of the positive first connector such that the negative first connector is arranged to be releasable from the respective insulated housing prior to the positive first connector responsive to high temperature resulting from a high current flow through the conductive contact element.
